(19) United States
(12) Patent Application Publication
(10) Pub. No.: US 2024/0202892 A1
(43) Pub. Date: Jun. 20, 2024

(54) COMBINED TONE AND GAMUT MAPPING FOR AUGMENTED REALITY DISPLAY

(71) Applicant: Meta Platforms Technologies, LLC, Menlo Park, CA (US)

(72) Inventors: Pin-Chieh Huang, Chelmsford, MA (US); Edward Buckley, High Peak (GB); Christopher Francis Reidy, Bellevue, WA (US); Yuta Asano, Seattle, WA (US); Runzhe Zhang, West Lafayette, IN (US)

(21) Appl. No.: 18/065,840

(22) Filed: Dec. 14, 2022

(51) Int. Cl. G06T 5/00; G06T 11/00

(52) U.S. Cl. CPC G06T 5/009; G06T 11/001; G06T 2207/10024; G06T 2207/20208

(57) ABSTRACT

In one embodiment, a computing system may receive an image to be displayed on a display. The image may be associated with an input gamut and the display may be associated with an output gamut. The system may access a look-up-table that maps input colors to output colors. The output color of corresponding to each input color may be determined by adjusting a lightness of the input color according to a pre-determined tone curve while keeping the hue and chroma constant and (2) mapping the chroma to the output gamut of the display. The system may determine a final color for each pixel of the pixels of the image based on the look-up-table and an original color of that pixel. The system may display the final colors of the pixels on the display to represent the original colors of the image.

### TECHNICAL FIELD

This disclosure generally relates to artificial reality, such as virtual reality and augmented reality.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to a method which combines tone mapping and gamut mapping to adjust the pixel lightness for displaying an image and optimize the color values of the image to be displayed on AR displays. Input images to be displayed on AR displays may be usually defined in an sRGB color space corresponding to an sRGB gamut. AR displays may normally have a different color gamut than sRGB gamut. Thus, gamut mapping may be needed from the sRGB to the display gamut for achieving an optimal display result. Also, the system may use a combined approach of tone mapping and gamut mapping to optimize the image pixel values and improve image visibility. The system may first determine, for each color hue, an input gamut boundary in the lightness-chroma space of the sRGB gamut and an output gamut boundary in the lightness-chroma space as defined by the display gamut. Both of the input and output gamut boundaries may be approximated by respective curves (e.g., piecewise curves). For example, for a given hue, the gamut boundary may be approximated by a piecewise curve where the vertices correspond to the places in which it was sampled).

For the tone mapping, the system may first determine a tone mapping curve which is customized based on the display and a number of other factors (e.g., the background illuminance, the foreground illuminance, the contrast of the foreground and background). The tone mapping curve may map the lightness of the input RGB values to new lightness levels with variable gains along the tone mapping curve. For example, the dimmest range may have the highest gain values and have a greater amount of change in the lightness of the input RGB values. The middle range may have relatively greater gain values (greater than the brightest range but less than the dimmest range). The lightest range may have the lowest the gain values. The tone mapping process may consider the input gamut boundary for the lightness range and avoid pushing the lightness level beyond the input gamut boundary (which would result in clipping effect). The tone mapping process may be performed in an L*C*H color space to the lightness (L*) at fixed hue (H) and chroma (C*) and the result will fit within the minimum and maximum lightness level. As a result, the lightness of input RGB values in different ranges may be mapped to different lightness levels in a non-proportional manner with different gain values. The details in the dimmest and middle range may become much brighter for an easy perception by viewers. In the meantime, the brightest range can avoid oversaturation effect. Also, the overall contrast of the images viewed on the AR display (e.g., a see-through display) may be generally maintained.

For the gamut mapping (e.g., in an L*C*H color space), the system may scale the chroma from the range of the input gamut to match the chroma range of the output gamut, while keeping L* at constant adjusted lightness (adjusted in the previous step). The scaling may be proportional, which means that the output chroma values in the output gamut can be proportional to the input chroma values in the input gamut range. However, in some embodiments, the scaling does not have to be proportional. The output chroma values within the output gamut range may have any pre-determined fixed relationship with the input chroma values within the input gamut range. By mapping the chroma values from the input gamut to the output gamut, the image color values may be optimized to maximize the usage of the output gamut range. As a result, the optimized image may be more colorful and provide better user experience. The gamut mapping scheme may be based on, for example, but not limited to, the LLIN or CLLIN method.

The system can perform the tone mapping first and perform the gamut mapping after that. Alternatively, the system can do it in a reserved order by performing the gamut mapping before performing tone mapping. For example, the system can first scale the chroma values by scaling the input gamut to match the output gamut along the chroma dimension, while keeping the lightness unchanged. Then, the system may use a tone curve to fit the lightness to the boundary of the output gamut. The end result may be similar, and the optimized image may have higher overall lightness to allow viewers to see more details and will be more colorful as perceived by the viewers. The tone mapping and gamut mapping process may be repeated for each color hue associated with the input image. However, computing on-the-fly may be too demanding to the computational resources and power. As such, the system pre-computes a 3D LUT (three-dimensional look-up table) which combines both the tone mapping and the gamut mapping. At run time, the system can access the 3D LUT which directly provides the output colors based on the input colors and interpolation. As a result, the tone mapping and gamut mapping may be not performed at runtime to minimize computational resources or power.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 1C illustrates an example architecture of a display engine.

FIG. 1D illustrates an example graphic pipeline of the display engine for generating display image data.

FIG. 2A illustrates an example scanning waveguide display.

FIG. 2B illustrates an example scanning operation of the scanning waveguide display.

FIG. 3A illustrates an example 2D micro-LED waveguide display.

FIG. 3B illustrates an example waveguide configuration for the 2D micro-LED waveguide display.

FIG. 4A illustrates an example input gamut associated with images to be displayed.

FIG. 4B illustrates an example output gamut associated with the display for displaying images.

FIG. 4C illustrates a comparison of the boundaries of the example input gamut and output gamut.

FIG. 5A illustrates an example display gamma curve and the compressed dynamic range for a foreground image in a background environment in linear RGB and sRGB domains.

FIG. 5B illustrates an example tone mapping curve.

FIGS. 6A-6C illustrate an example process for using combined tone mapping and gamut mapping to optimize pixel colors of the images to be displayed.

FIGS. 6D-6E illustrate an example process where the system performs gamut mapping by scaling the chroma before performing tone mapping by scaling the lightness.

FIG. 7A illustrates an example process to scale both the chroma and lightness simultaneously from a centroid of the input gamut.

FIG. 7B illustrates an example process to scale both the chroma and lightness simultaneously from variable focal points.

FIG. 8 illustrates an example method for displaying an image using combined tone and gamut mapping technique.

FIG. 9 illustrates an example computer system.

### DESCRIPTION OF EXAMPLE EMBODIMENTS

The number of available bits in a display may limit the display's color depth or gray scale levels. To achieve display results with higher effective grayscale level, displays may use a series of temporal subframes with less grayscale level bits to create the illusion of a target image with more grayscale level bits. The series of subframes may be generated using a segmented quantization process with each segment having a different weight. The quantization errors may be dithered spatially within each subframe. However, the subframes generated in this way may have a naïve stacking property (e.g., direct stacking property without using a dither mask) and each subframe may be generated without considering what has been displayed in former subframes causing the subframes to have some artifacts that could negatively impact the experience of the viewers.

In particular embodiments, the system may use a mask-based spatio-temporal dithering method for generating each subframe of a series of subframes taking into consideration what has been displayed in the previous subframes preceding that subframe. The system may determine target pixel values of current subframe by compensating the quantization errors of the previously subframes. The pixel values of the current subframe may be determined by quantizing the target pixel values based on a dither mask having a spatial stacking property. The quantization errors may be propagated into subsequent subframes through an error buffer. The generated subframes may satisfy both spatial and temporal stacking property and provide better image display results and better user experience.

Particular embodiments of the system may provide better image quality and improve user experience for AR/VR display by using multiple subframe images with less color depth to represent an image with greater color depth. Particular embodiments of the system may generate subframe images with reduced or eliminated temporal artifacts. Particular embodiments of the system may allow AR/VR display system to reduce the space and complexity of pixel circuits by having less gray level bits, and therefore miniaturize the size of the display system. Particular embodiments of the system may make it possible for AR/VR displays to operate in monochrome mode with digital pixel circuits without using analog pixel circuits for full RGB operations.

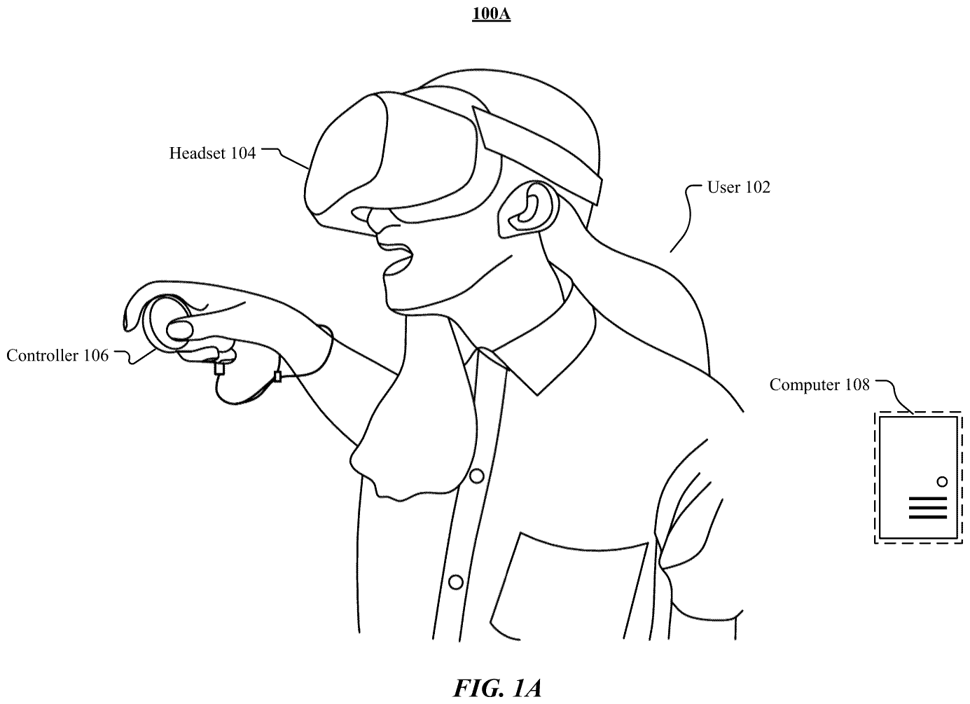

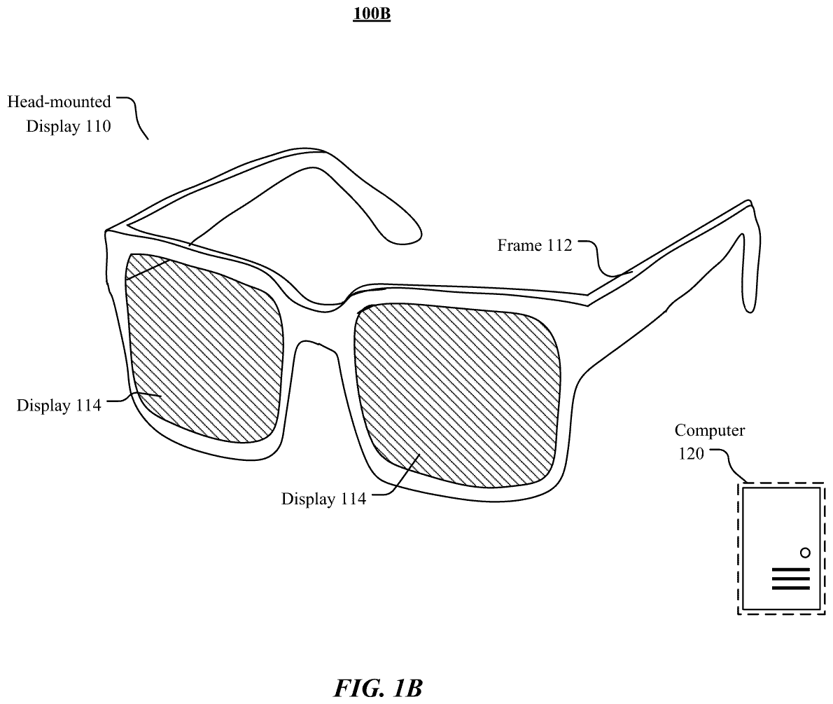

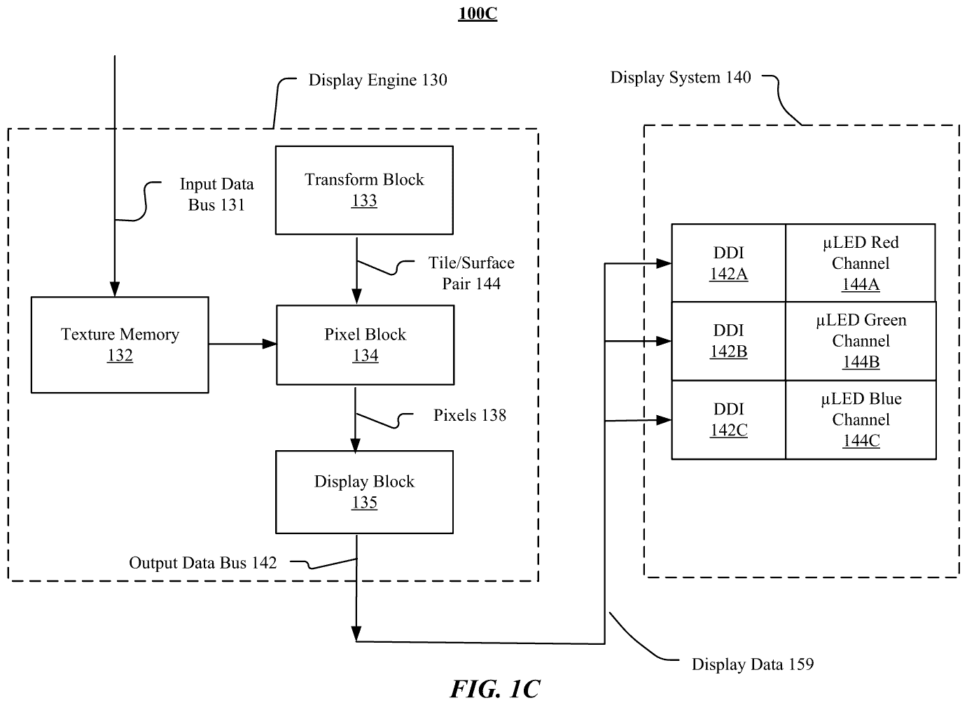

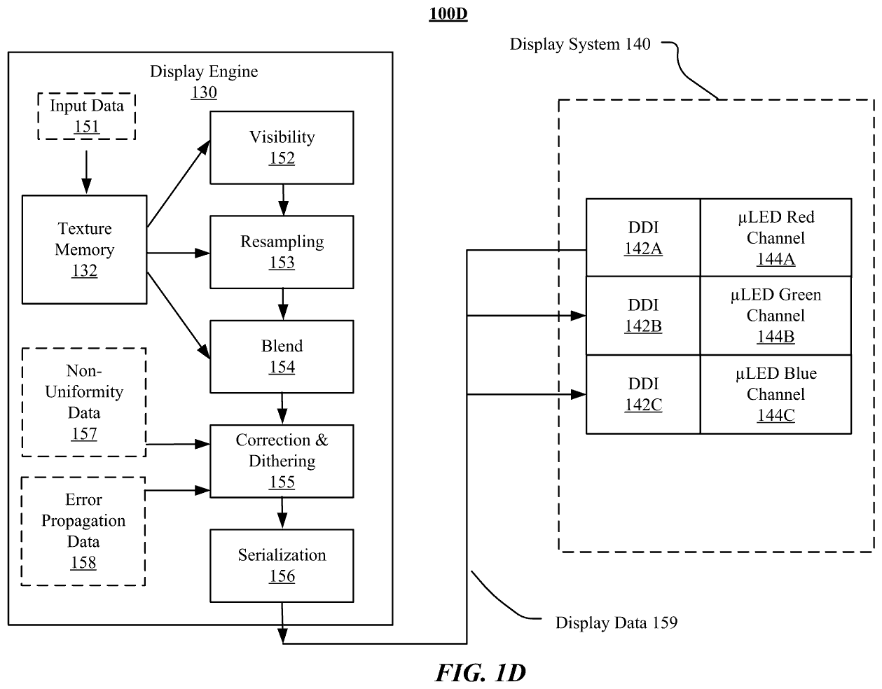

FIG. 1A illustrates an example artificial reality system 100A. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

FIG. 1C illustrates an example architecture 100C of a display engine 130. In particular embodiments, the processes and methods as described in this disclosure may be embodied or implemented within a display engine 130 (e.g., in the display block 135). The display engine 130 may include, for example, but is not limited to, a texture memory 132, a transform block 133, a pixel block 134, a display block 135, input data bus 131, output data bus 142, etc. In particular embodiments, the display engine 130 may include one or more graphic pipelines for generating images to be rendered on the display. For example, the display engine may use the graphic pipeline(s) to generate a series of subframe images based on a mainframe image and a viewpoint or view angle of the user as measured by one or more eye tracking sensors. The mainframe image may be generated or/and loaded in to the system at a mainframe rate of 30-90 Hz and the subframe rate may be generated at a subframe rate of 1-2 kHz. In particular embodiments, the display engine 130 may include two graphic pipelines for the user's left and right eyes. One of the graphic pipelines may include or may be implemented on the texture memory 132, the transform block 133, the pixel block 134, the display block 135, etc. The display engine 130 may include another set of transform block, pixel block, and display block for the other graphic pipeline. The graphic pipeline(s) may be controlled by a controller or control block (not shown) of the display engine 130. In particular embodiments, the texture memory 132 may be included within the control block or may be a memory unit external to the control block but local to the display engine 130. One or more of the components of the display engine 130 may be configured to communicate via a high-speed bus, shared memory, or any other suitable methods. This communication may include transmission of data as well as control signals, interrupts or/and other instructions. For example, the texture memory 132 may be configured to receive image data through the input data bus 211. As another example, the display block 135 may send the pixel values to the display system 140 through the output data bus 142. In particular embodiments, the display system 140 may include three color channels (e.g., 114A, 114B, 114C) with respective display driver ICs (DDIs) of 142A, 142B, and 143B. In particular embodiments, the display system 140 may include, for example, but is not limited to, light-emitting diode (LED) displays, organic light-emitting diode (OLED) displays, active matrix organic light-emitting diode (AMLED) displays, liquid crystal display (LCD), micro light-emitting diode (μLED) display, electroluminescent displays (ELDs), or any suitable displays.

In particular embodiments, the display engine 130 may include a controller block (not shown). The control block may receive data and control packages such as position data and surface information from controllers external to the display engine 130 though one or more data buses. For example, the control block may receive input stream data from a body wearable computing system. The input data stream may include a series of mainframe images generated at a mainframe rate of 30-90 Hz. The input stream data including the mainframe images may be converted to the required format and stored into the texture memory 132. In particular embodiments, the control block may receive input from the body wearable computing system and initialize the graphic pipelines in the display engine to prepare and finalize the image data for rendering on the display. The data and control packets may include information related to, for example, one or more surfaces including texel data, position data, and additional rendering instructions. The control block may distribute data as needed to one or more other blocks of the display engine 130. The control block may initiate the graphic pipelines for processing one or more frames to be displayed. In particular embodiments, the graphic pipelines for the two eye display systems may each include a control block or share the same control block.

In particular embodiments, the transform block 133 may determine initial visibility information for surfaces to be displayed in the artificial reality scene. In general, the transform block 133 may cast rays from pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye tracking sensors, and/or any suitable tracking/localization algorithms, such as simultaneous localization and mapping (SLAM)) into the artificial scene where surfaces are positioned and may produce tile/surface pairs 144 to send to the pixel block 134. In particular embodiments, the transform block 133 may include a four-stage pipeline as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the eye display systems the headset system. The transform block 133 may determine whether each ray bundle intersects with surfaces in the scene by comparing a bounding box of each tile to bounding boxes for the surfaces. If a ray bundle does not intersect with an object, it may be discarded. After the tile-surface intersections are detected, the corresponding tile/surface pairs may be passed to the pixel block 134.

In particular embodiments, the pixel block 134 may determine color values or grayscale values for the pixels based on the tile-surface pairs. The color values for each pixel may be sampled from the texel data of surfaces received and stored in texture memory 132. The pixel block 134 may receive tile-surface pairs from the transform block 133 and may schedule bilinear filtering using one or more filer blocks. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation). In particular embodiments, the pixel block 134 may process the red, green, and blue color components separately for each pixel. In particular embodiments, the display may include two pixel blocks for the two eye display systems. The two pixel blocks of the two eye display systems may work independently and in parallel with each other. The pixel block 134 may then output its color determinations (e.g., pixels 138) to the display block 135. In particular embodiments, the pixel block 134 may composite two or more surfaces into one surface to when the two or more surfaces have overlapping areas. A composed surface may need less computational resources (e.g., computational units, memory, power, etc.) for the resampling process.

In particular embodiments, the display block 135 may receive pixel color values from the pixel block 134, covert the format of the data to be more suitable for the scanline output of the display, apply one or more lightness corrections to the pixel color values, and prepare the pixel color values for output to the display. In particular embodiments, the display block 135 may each include a row buffer and may process and store the pixel data received from the pixel block 134. The pixel data may be organized in quads (e.g., 2×2 pixels per quad) and tiles (e.g., 16×16 pixels per tile). The display block 135 may convert tile-order pixel color values generated by the pixel block 134 into scanline or row-order data, which may be required by the physical displays. The lightness corrections may include any required lightness correction, gamma mapping, and dithering. The display block 135 may output the corrected pixel color values directly to the driver of the physical display (e.g., pupil display) or may output the pixel values to a block external to the display engine 130 in a variety of formats. For example, the eye display systems of the headset system may include additional hardware or software to further customize backend color processing, to support a wider interface to the display, or to optimize display speed or fidelity.

In particular embodiments, the dithering methods and processes (e.g., spatial dithering method, temporal dithering methods, and spatio-temporal methods) as described in this disclosure may be embodied or implemented in the display block 135 of the display engine 130. In particular embodiments, the display block 135 may include a model-based dithering algorithm or a dithering model for each color channel and send the dithered results of the respective color channels to the respective display driver ICs (e.g., 142A, 142B, 142C) of display system 140. In particular embodiments, before sending the pixel values to the respective display driver ICs (e.g., 142A, 142B, 142C), the display block 135 may further include one or more algorithms for correcting, for example, pixel non-uniformity, LED non-ideality, waveguide non-uniformity, display defects (e.g., dead pixels), etc.

In particular embodiments, graphics applications (e.g., games, maps, content-providing apps, etc.) may build a scene graph, which is used together with a given view position and point in time to generate primitives to render on a GPU or display engine. The scene graph may define the logical and/or spatial relationship between objects in the scene. In particular embodiments, the display engine 130 may also generate and store a scene graph that is a simplified form of the full application scene graph. The simplified scene graph may be used to specify the logical and/or spatial relationships between surfaces (e.g., the primitives rendered by the display engine 130, such as quadrilaterals or contours, defined in 3D space, that have corresponding textures generated based on the mainframe rendered by the application). Storing a scene graph allows the display engine 130 to render the scene to multiple display frames and to adjust each element in the scene graph for the current viewpoint (e.g., head position), the current object positions (e.g., they could be moving relative to each other) and other factors that change per display frame. In addition, based on the scene graph, the display engine 130 may also adjust for the geometric and color distortion introduced by the display subsystem and then composite the objects together to generate a frame. Storing a scene graph allows the display engine 130 to approximate the result of doing a full render at the desired high frame rate, while actually running the GPU or display engine 130 at a significantly lower rate.

FIG. 1D illustrates an example graphic pipeline 100D of the display engine 130 for generating display image data. In particular embodiments, the graphic pipeline 100D may include a visibility step 152, where the display engine 130 may determine the visibility of one or more surfaces received from the body wearable computing system. The visibility step 152 may be performed by the transform block (e.g., 2133 in FIG. 1C) of the display engine 130. The display engine 130 may receive (e.g., by a control block or a controller) input data 151 from the body-wearable computing system. The input data 151 may include one or more surfaces, texel data, position data, RGB data, and rendering instructions from the body wearable computing system. The input data 151 may include mainframe images with 30-90 frames per second (FPS). The main frame image may have color depth of, for example, 24 bits per pixel. The display engine 130 may process and save the received input data 151 in the texel memory 132. The received data may be passed to the transform block 133 which may determine the visibility information for surfaces to be displayed. The transform block 133 may cast rays for pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye trackers, and/or any suitable tracking/localization algorithms, such as simultaneous localization and mapping (SLAM)) into the artificial scene where surfaces are positioned and produce surface-tile pairs to send to the pixel block 134.

In particular embodiments, the graphic pipeline 100D may include a resampling step 153, where the display engine 130 may determine the color values from the tile-surfaces pairs to produce pixel color values. The resampling step 153 may be performed by the pixel block 134 in FIG. 1C) of the display engine 130. The pixel block 134 may receive tile-surface pairs from the transform block 133 and may schedule bilinear filtering. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation) and output the determined pixel values to the respective display block 135.

In particular embodiments, the graphic pipeline 100D may include a bend step 154, a correction and dithering step 155, a serialization step 156, etc. In particular embodiments, the bend step, correction and dithering step, and serialization steps of 154, 155, and 156 may be performed by the display block (e.g., 135 in FIG. 1C) of the display engine 130. The correction and dithering step 155 may be based on the non-uniformity data 157 and error propagation data 158. The display engine 130 may blend the display content for display content rendering, apply one or more lightness corrections to the pixel color values, perform one or more dithering algorithms for dithering the quantization errors both spatially and temporally, serialize the pixel values for scanline output for the physical display, and generate the display data 159 suitable for the display system 140. The display engine 130 may send the display data 159 to the display system 140. In particular embodiments, the display system 140 may include three display driver ICs (e.g., 142A, 142B, 142C) for the pixels of the three color channels of RGB (e.g., 144A, 144B, 144C).

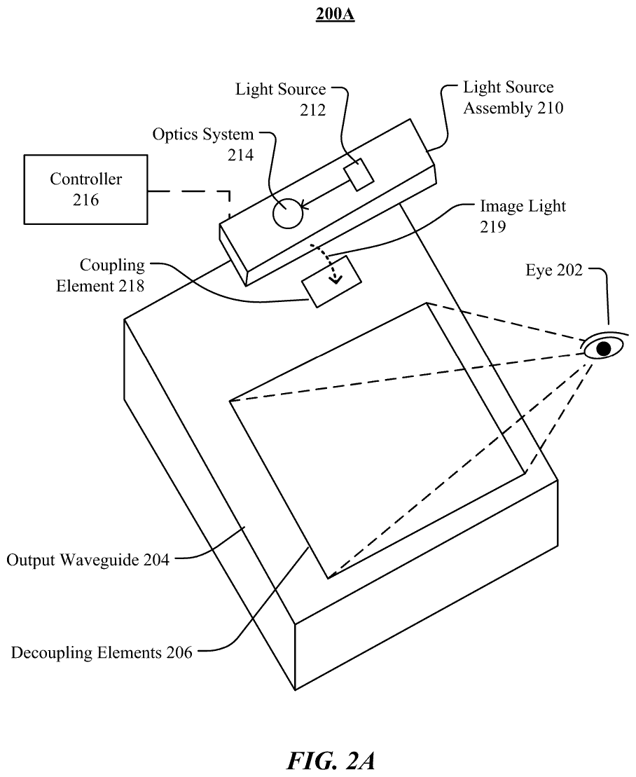

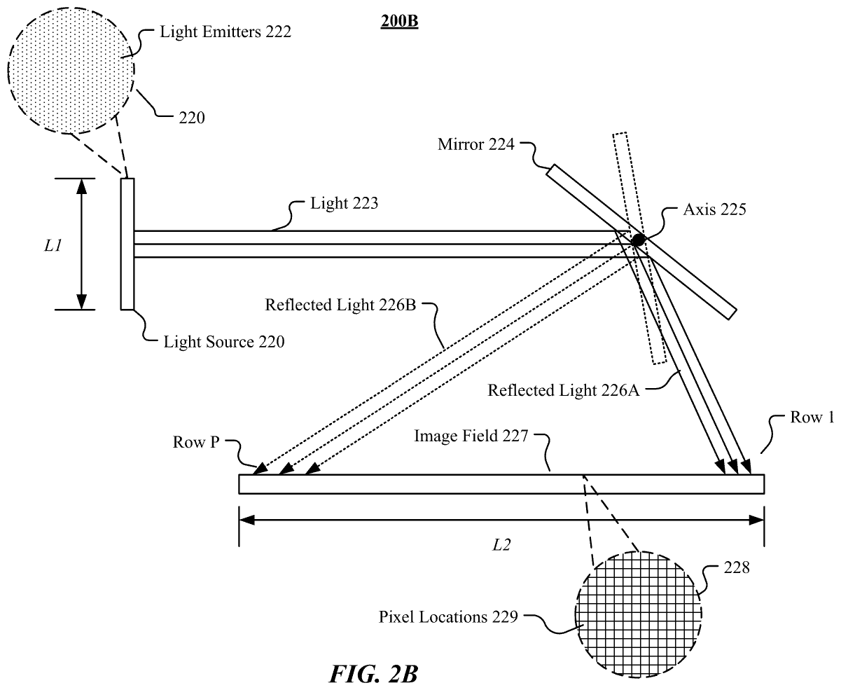

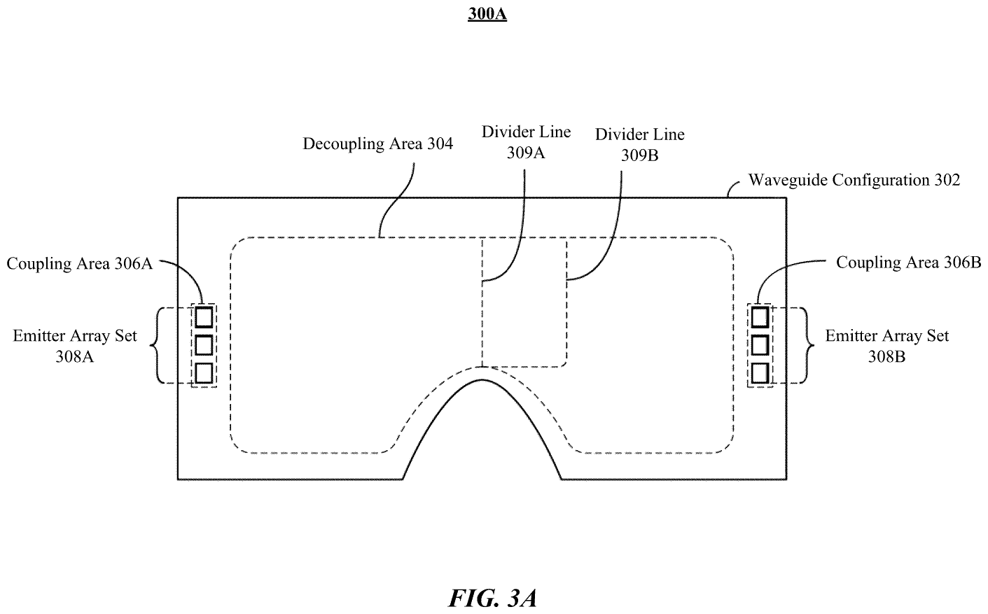

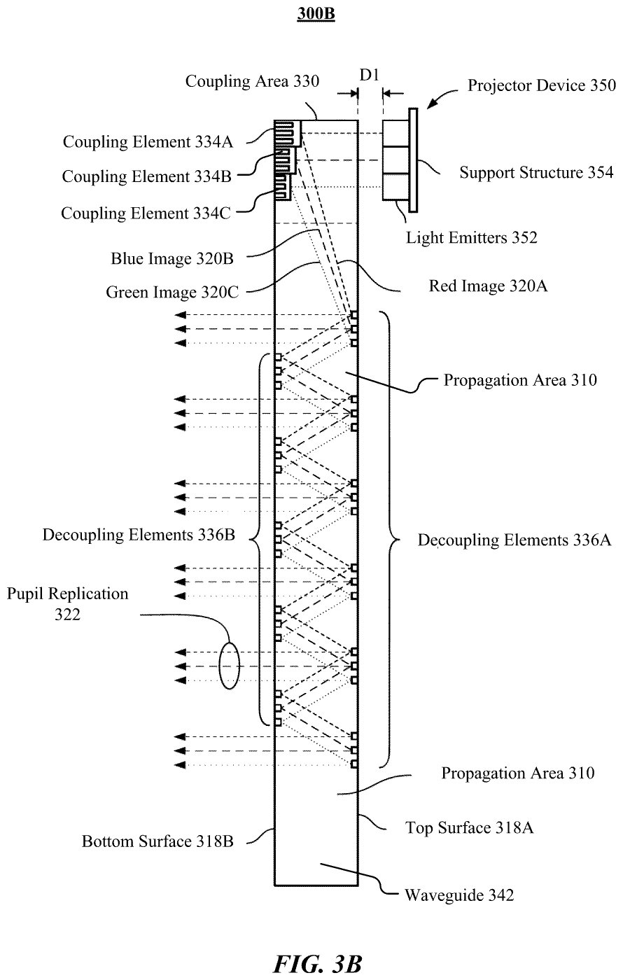

FIG. 2A illustrates an example scanning waveguide display 200A. In particular embodiments, the head-mounted display (HMD) of the AR/VR system may include a near eye display (NED) which may be a scanning waveguide display 200A. The scanning waveguide display 200A may include a light source assembly 210, an output waveguide 204, a controller 216, etc. The scanning waveguide display 200A may provide images for both eyes or for a single eye. For purposes of illustration, FIG. 3A shows the scanning waveguide display 200A associated with a single eye 202. Another scanning waveguide display (not shown) may provide image light to the other eye of the user and the two scanning waveguide displays may share one or more components or may be separated. The light source assembly 210 may include a light source 212 and an optics system 214. The light source 212 may include an optical component that could generate image light using an array of light emitters. The light source 212 may generate image light including, for example, but not limited to, red image light, blue image light, green image light, infra-red image light, etc. The optics system 214 may perform a number of optical processes or operations on the image light generated by the light source 212. The optical processes or operations performed by the optics systems 214 may include, for example, but are not limited to, light focusing, light combining, light conditioning, scanning, etc.

In particular embodiments, the optics system 214 may include a light combining assembly, a light conditioning assembly, a scanning mirror assembly, etc. The light source assembly 210 may generate and output an image light 219 to a coupling element 218 of the output waveguide 204. The output waveguide 204 may be an optical waveguide that could output image light to the user eye 202. The output waveguide 204 may receive the image light 219 at one or more coupling elements 218 and guide the received image light to one or more decoupling elements 206. The coupling element 218 may be, for example, but is not limited to, a diffraction grating, a holographic grating, any other suitable elements that can couple the image light 219 into the output waveguide 204, or a combination thereof. As an example and not by way of limitation, if the coupling element 350 is a diffraction grating, the pitch of the diffraction grating may be chosen to allow the total internal reflection to occur and the image light 219 to propagate internally toward the decoupling element 206. The pitch of the diffraction grating may be in the range of 300 nm to 600 nm. The decoupling element 206 may decouple the total internally reflected image light from the output waveguide 204. The decoupling element 206 may be, for example, but is not limited to, a diffraction grating, a holographic grating, any other suitable element that can decouple image light out of the output waveguide 204, or a combination thereof. As an example and not by way of limitation, if the decoupling element 206 is a diffraction grating, the pitch of the diffraction grating may be chosen to cause incident image light to exit the output waveguide 204. The orientation and position of the image light exiting from the output waveguide 204 may be controlled by changing the orientation and position of the image light 219 entering the coupling clement 218. The pitch of the diffraction grating may be in the range of 300 nm to 600 nm.

In particular embodiments, the output waveguide 204 may be composed of one or more materials that can facilitate total internal reflection of the image light 219. The output waveguide 204 may be composed of one or more materials including, for example, but not limited to, silicon, plastic, glass, polymers, or some combination thereof. The output waveguide 204 may have a relatively small form factor. As an example and not by way of limitation, the output waveguide 204 may be approximately 50 mm wide along X-dimension, 30 mm long along Y-dimension and 0.5-1 mm thick along Z-dimension. The controller 216 may control the scanning operations of the light source assembly 210. The controller 216 may determine scanning instructions for the light source assembly 210 based at least on the one or more display instructions for rendering one or more images. The display instructions may include an image file (e.g., bitmap) and may be received from, for example, a console or computer of the AR/VR system. Scanning instructions may be used by the light source assembly 210 to generate image light 219. The scanning instructions may include, for example, but are not limited to, an image light source type (e.g., monochromatic source, polychromatic source), a scanning rate, a scanning apparatus orientation, one or more illumination parameters, or some combination thereof. The controller 216 may include a combination of hardware, software, firmware, or any suitable components supporting the functionality of the controller 216.

FIG. 2B illustrates an example scanning operation of a scanning waveguide display 200B. The light source 220 may include an array of light emitters 222 (as represented by the dots in inset) with multiple rows and columns. The light 223 emitted by the light source 220 may include a set of collimated beams of light emitted by each column of light emitters 222. Before reaching the mirror 224, the light 223 may be conditioned by different optical devices such as the conditioning assembly (not shown). The mirror 224 may reflect and project the light 223 from the light source 220 to the image field 227 by rotating about an axis 225 during scanning operations. The mirror 224 may be a microelectromechanical system (MEMS) mirror or any other suitable mirror. As the mirror 224 rotates about the axis 225, the light 223 may be projected to a different part of the image field 227, as illustrated by the reflected part of the light 226A in solid lines and the reflected part of the light 226B in dash lines.

In particular embodiments, the image field 227 may receive the light 226A-B as the mirror 224 rotates about the axis 225 to project the light 226A-B in different directions. For example, the image field 227 may correspond to a portion of the coupling element 218 or a portion of the decoupling element 206 in FIG. 2A. In particular embodiments, the image field 227 may include a surface of the coupling element 206. The image formed on the image field 227 may be magnified as light travels through the output waveguide 220. In particular embodiments, the image field 227 may not include an actual physical structure but include an area to which the image light is projected to form the images. The image field 227 may also be referred to as a scan field. When the light 223 is projected to an area of the image field 227, the area of the image field 227 may be illuminated by the light 223. The image field 227 may include a matrix of pixel locations 229 (represented by the blocks in inset 228) with multiple rows and columns. The pixel location 229 may be spatially defined in the area of the image field 227 with a pixel location corresponding to a single pixel. In particular embodiments, the pixel locations 229 (or the pixels) in the image field 227 may not include individual physical pixel elements. Instead, the pixel locations 229 may be spatial areas that are defined within the image field 227 and divide the image field 227 into pixels. The sizes and locations of the pixel locations 229 may depend on the projection of the light 223 from the light source 220. For example, at a given rotation angle of the mirror 224, light beams emitted from the light source 220 may fall on an area of the image field 227. As such, the sizes and locations of pixel locations 229 of the image field 227 may be defined based on the location of each projected light beam. In particular embodiments, a pixel location 229 may be subdivided spatially into subpixels (not shown). For example, a pixel location 229 may include a red subpixel, a green subpixel, and a blue subpixel. The red, green and blue subpixels may correspond to respective locations at which one or more red, green and blue light beams are projected. In this case, the color of a pixel may be based on the temporal and/or spatial average of the pixel's subpixels.

In particular embodiments, the light emitters 222 may illuminate a portion of the image field 227 (e.g., a particular subset of multiple pixel locations 229 on the image field 227) with a particular rotation angle of the mirror 224. In particular embodiment, the light emitters 222 may be arranged and spaced such that a light beam from each of the light emitters 222 is projected on a corresponding pixel location 229. In particular embodiments, the light emitters 222 may include a number of light-emitting elements (e.g., micro-LEDs) to allow the light beams from a subset of the light emitters 222 to be projected to a same pixel location 229. In other words, a subset of multiple light emitters 222 may collectively illuminate a single pixel location 229 at a time. As an example and not by way of limitation, a group of light emitter including eight light-emitting elements may be arranged in a line to illuminate a single pixel location 229 with the mirror 224 at a given orientation angle.

In particular embodiments, the number of rows and columns of light emitters 222 of the light source 220 may or may not be the same as the number of rows and columns of the pixel locations 229 in the image field 227. In particular embodiments, the number of light emitters 222 in a row may be equal to the number of pixel locations 229 in a row of the image field 227 while the light emitters 222 may have fewer columns than the number of pixel locations 229 of the image field 227. In particular embodiments, the light source 220 may have the same number of columns of light emitters 222 as the number of columns of pixel locations 229 in the image field 227 but fewer rows. As an example and not by way of limitation, the light source 220 may have about 1280 columns of light emitters 222 which may be the same as the number of columns of pixel locations 229 of the image field 227, but only a handful rows of light emitters 222. The light source 220 may have a first length L1 measured from the first row to the last row of light emitters 222. The image field 530 may have a second length L2, measured from the first row (e.g., Row 1) to the last row (e.g., Row P) of the image field 227. The L2 may be greater than L1 (e.g., L2 is 50 to 10,000 times greater than L1).

In particular embodiments, the number of rows of pixel locations 229 may be larger than the number of rows of light emitters 222. The display device 200B may use the mirror 224 to project the light 223 to different rows of pixels at different time. As the mirror 520 rotates and the light 223 scans through the image field 227, an image may be formed on the image field 227. In some embodiments, the light source 220 may also has a smaller number of columns than the image field 227. The mirror 224 may rotate in two dimensions to fill the image field 227 with light, for example, using a raster-type scanning process to scan down the rows then moving to new columns in the image field 227. A complete cycle of rotation of the mirror 224 may be referred to as a scanning period which may be a predetermined cycle time during which the entire image field 227 is completely scanned. The scanning of the image field 227 may be determined and controlled by the mirror 224 with the light generation of the display device 200B being synchronized with the rotation of the mirror 224. As an example and not by way of limitation, the mirror 224 may start at an initial position projecting light to Row 1 of the image field 227, and rotate to the last position that projects light to Row P of the image field 227, and then rotate back to the initial position during one scanning period. An image (e.g., a frame) may be formed on the image field 227 per scanning period. The frame rate of the display device 200B may correspond to the number of scanning periods in a second. As the mirror 224 rotates, the light may scan through the image field to form images. The actual color value and light intensity or lightness of a given pixel location 229 may be a temporal sum of the color various light beams illuminating the pixel location during the scanning period. After completing a scanning period, the mirror 224 may revert back to the initial position to project light to the first few rows of the image field 227 with a new set of driving signals being fed to the light emitters 222. The same process may be repeated as the mirror 224 rotates in cycles to allow different frames of images to be formed in the scanning field 227.

FIG. 3A illustrates an example 2D micro-LED waveguide display 300A. In particular embodiments, the display 300A may include an elongate waveguide configuration 302 that may be wide or long enough to project images to both eyes of a user. The waveguide configuration 302 may include a decoupling area 304 covering both eyes of the user. In order to provide images to both eyes of the user through the waveguide configuration 302, multiple coupling areas 306A-B may be provided in a top surface of the waveguide configuration 302. The coupling areas 306A and 306B may include multiple coupling elements to receive image light from light emitter array sets 308A and 308B, respectively. Each of the emitter array sets 308A-B may include a number of monochromatic emitter arrays including, for example, but not limited to, a red emitter array, a green emitter array, and a blue emitter array. In particular embodiments, the emitter array sets 308A-B may further include a white emitter array or an emitter array emitting other colors or any combination of any multiple colors. In particular embodiments, the waveguide configuration 302 may have the emitter array sets 308A and 308B covering approximately identical portions of the decoupling area 304 as divided by the divider line 309A. In particular embodiments, the emitter array sets 308A and 308B may provide images to the waveguide of the waveguide configuration 302 asymmetrically as divided by the divider line 309B. For example, the emitter array set 308A may provide image to more than half of the decoupling area 304. In particular embodiments, the emitter array sets 308A and 308B may be arranged at opposite sides (e.g., 180° apart) of the waveguide configuration 302 as shown in FIG. 3B. In other embodiments, the emitter array sets 308A and 308B may be arranged at any suitable angles. The waveguide configuration 302 may be planar or may have a curved cross-sectional shape to better fit to the face/head of a user.

FIG. 3B illustrates an example waveguide configuration 300B for the 2D micro-LED waveguide display. In particular embodiments, the waveguide configuration 300B may include a projector device 350 coupled to a waveguide 342. The projector device 320 may include a number of light emitters 352 (e.g., monochromatic emitters) secured to a support structure 354 (e.g., a printed circuit board or other suitable support structure). The waveguide 342 may be separated from the projector device 350 by an air gap having a distance of D1 (e.g., approximately 50 μm to approximately 500 μm). The monochromatic images projected by the projector device 350 may pass through the air gap toward the waveguide 342. The waveguide 342 may be formed from a glass or plastic material. The waveguide 342 may include a coupling area 330 including a number of coupling elements 334A-C for receiving the emitted light from the projector device 350. The waveguide 342 may include a decoupling area with a number of decoupling elements 336A on the top surface 318A and a number of decoupling elements 336B on the bottom surface 318B. The area within the waveguide 342 in between the decoupling elements 336A and 336B may be referred as a propagation area 310, in which image light received from the projector device 350 and coupled into the waveguide 342 by the coupling element 334 may propagate laterally within the waveguide 342.

The coupling area 330 may include coupling elements (e.g., 334A, 334B, 334C) configured and dimensioned to couple light of predetermined wavelengths (e.g., red, green, blue). When a white light emitter array is included in the projector device 350, the portion of the white light that falls in the predetermined wavelengths may be coupled by each of the coupling elements 334A-C. In particular embodiments, the coupling elements 334A-B may be gratings (e.g., Bragg gratings) dimensioned to couple a predetermined wavelength of light. In particular embodiments, the gratings of each coupling clement may exhibit a separation distance between gratings associated with the predetermined wavelength of light and each coupling element may have different grating separation distances. Accordingly, each coupling element (e.g., 334A-C) may couple a limited portion of the white light from the white light emitter array of the projector device 350 if white light emitter array is included in the projector device 350. In particular embodiments, each coupling element (e.g., 334A-C) may have the same grating separation distance. In particular embodiments, the coupling elements 334A-C may be or include a multiplexed coupler.

As illustrated in FIG. 3B, a red image 320A, a blue image 320B, and a green image 320C may be coupled by the coupling elements 334A, 334B, 334C, respectively, into the propagation area 310 and may begin to traverse laterally within the waveguide 342. A portion of the light may be projected out of the waveguide 342 after the light contacts the decoupling element 336A for one-dimensional pupil replication, and after the light contacts both the decoupling elements 336A and 336B for two-dimensional pupil replication. In two-dimensional pupil replication, the light may be projected out of the waveguide 342 at locations where the pattern of the decoupling element 336A intersects the pattern of the decoupling element 336B. The portion of the light that is not projected out of the waveguide 342 by the decoupling element 336A may be reflected off the decoupling element 336B. The decoupling element 336B may reflect all incident light back toward the decoupling element 336A. Accordingly, the waveguide 342 may combine the red image 320A, the blue image 320B, and the green image 320C into a polychromatic image instance which may be referred as a pupil replication 322. The polychromatic pupil replication 322 may be projected to the user's eyes which may interpret the pupil replication 322 as a full color image (e.g., an image including colors addition to red, green, and blue). The waveguide 342 may produce tens or hundreds of pupil replication 322 or may produce a single replication 322.

In particular embodiments, the AR/VR system may use scanning waveguide displays or 2D micro-LED displays for displaying AR/VR content to users. In order to miniaturize the AR/VR system, the display system may need to miniaturize the space for pixel circuits and may have limited number of available bits for the display. The number of available bits in a display may limit the display's color depth or gray scale level, and consequently limit the quality of the displayed images. Furthermore, the waveguide displays used for AR/VR systems may have nonuniformity problem cross all display pixels. The compensation operations for pixel nonuniformity may result in loss on image grayscale and further reduce the quality of the displayed images. For example, a waveguide display with 8-bit pixels (i.e., 256 gray level) may equivalently have 6-bit pixels (i.e., 64 gray level) after compensation of the nonuniformity (e.g., 8:1 waveguide nonuniformity, 0.1% dead micro-LED pixel, and 20% micro-LED intensity nonuniformity).

To improve the displayed image quality, displays with limited color depth or gray scale level may use spatio dithering to spread quantization errors to neighboring pixels and generate the illusion of increased color depth or gray scale level. To further increase the color depth or gray scale level, displays may generate a series of temporal subframe images with less gray level bits to give the illusion of a target image which has more gray level bits. Each subframe image may be dithered using spatio dithering techniques within that subframe image. The temporal average or aggregation of the series of subframe image may correspond to the image as perceived by the viewer. For example, for display an image with 8-bit pixels (i.e., 256 gray levels), the system may use four subframe images each having 6-bit pixels (i.e., 64 gray level) to represent the 8-bit target image. As another example, an image with 8-bit pixels (i.e., 256 gray levels) may be represented by 16 subframe images each having 4-bit pixels (i.e., 16 gray levels). This would allow the display system to render images of more gray level (e.g., 8-bit pixels) with pixel circuits and supporting hardware for less gray levels (e.g., 6-bit pixels or 4-bit pixels), and therefore reduce the space and size of the display system.

AR displays usually have limited contrast ranges for displayed images due to the see-through display properties. For example, the dark color on AR display may be not an ideal dark and the white color may not be an ideal white. Images directly displayed on AR display without tone mapping or/and gamut mapping may be less optimal as perceived by viewers. For examples, the displayed images may be too dim or lack contrast in the displayed environment and could be hard for viewers to perceive the details of the dim regions of the image. As another example, the displayed images may be less colorful (de-saturated) than an optimal display quality or may have oversaturated color which leads to loss of details.

To solve these problems, particular embodiments in this disclosure may use a method that combines tone mapping and gamut mapping to adjust the pixel lightness and optimize the color values of the image to be displayed on AR displays. Input images to be displayed on AR displays may be usually defined in an sRGB color space corresponding to an sRGB gamut. AR displays may normally have a different color gamut than sRGB gamut. Thus, gamut mapping may be needed from the sRGB to the display gamut for achieving an optimal display result. Also, the system may use a combined approach of tone mapping and gamut mapping to optimize the image pixel values. The system may first determine, for each color hue, an input gamut boundary in the lightness-chroma space of the sRGB gamut and an output gamut boundary in the lightness-chroma space as defined by the display gamut. Both of the input and output gamut boundaries may be approximated by respective piecewise curves with vertices corresponding to the places in which it was sampled. The gamut mapping process can be operated in a perceptually-uniform and hue-invariant color space.

For the tone mapping process, the system may first determine a tone mapping curve which is customized based on the display and a number of other factors (e.g., the background illuminance, the foreground illuminance, the contrast of the foreground and background). The tone mapping curve may map the lightness of the input RGB values to new lightness levels with variable gains along the tone mapping curve. For example, the dimmest range may have the highest gain values and have a greater amount of change in the lightness of the input RGB values. The middle range may have relatively greater gain values (greater than the brightest range but less than the dimmest range). The lightest range may have the lowest the gain values. The tone mapping process may consider the input gamut boundary for the lightness range and avoid pushing the lightness level beyond the input gamut boundary (which would result in clipping effect). The tone mapping process may be performed in an L*C*H color space to the lightness (L*) at fixed hue (H) and chroma (C*) and the result will fit within the minimum and maximum lightness level. As a result, the lightness of input RGB values in different ranges may be mapped to different lightness levels in a non-proportional manner with different gain values. The details in the dimmest and middle range may become much brighter for an easy perception by viewers. In the meantime, the brightest range can avoid oversaturation effect. Also, the overall contrast of the images viewed on the AR display (see-through) may be generally maintained.

For the gamut mapping process (e.g., in an L*C*H color space), the system may scale the chroma from the range of the input gamut to match the chroma range of the output gamut, while keeping L* at constant adjusted lightness (adjusted in the previous step). The scaling may be proportional, which means that the output chroma values in the output gamut can be proportional to the input chroma values in the input gamut range. However, in some embodiments, the scaling does not have to be proportional. The output chroma values within the output gamut range may have any pre-determined fixed relationship with the input chroma values within the input gamut range. By mapping the chroma values from the input gamut to the output gamut, the image color values may be optimized to maximize the usage of the output gamut range. As a result, the optimized image may be more colorful and provide better user experience. The gamut mapping may be based on, for example, but not limited to, the LLIN or CLLIN method. The system can perform the tone mapping first and perform the gamut mapping after that. Alternatively, the system can do it in a reversed order by performing the gamut mapping before performing tone mapping. For example, the system can first scale the chroma values by scaling the input gamut to match the output gamut along the chroma dimension, while keeping the lightness unchanged. Then, the system may use a tone curve to fit the lightness to the boundary of the output gamut. The end result may be similar, and the optimized image may have higher overall lightness to allow viewers to see more details and will be more colorful as perceived by the viewers. In short, image contrast can be enhanced while color saturation can be preserved. The tone mapping and gamut mapping process may be repeated for each color hue associated with the input image. However, computing on-the-fly may be too demanding to the computational resources and power. As such, the system pre-computes a 3D LUT (three-dimensional look-up table) which combines both the tone mapping and the gamut mapping. At run time, the system can access the 3D LUT which directly provides the output colors based on the input colors. As a result, the tone mapping and gamut mapping may be performed based on the 3D LUT at runtime to minimize computational resources or power.

By combining the tone mapping and gamut mapping to optimize the pixel colors of displayed images, the system may provide better visibility for the details in the dimmer regions and at the same time provide more colorful display results. In particular embodiments, This may improve the overall contrast level of the image while maintaining color saturation. By constraining the lightness adjustment within the lightness range of the input gamut associated with the image, the system may avoid the oversaturation or clipping effect caused by pushing the lightness level beyond the gamut boundary. By using the 3D LUT which are generated based on the combined tone mapping and gamut mapping method, the system may avoid the on-the-fly computation to minimize the computational resources or power. On the other hand, in particular embodiments, 3D LUT may be customized for each foreground and background luminance combination (i.e., tone and gamut mapping can be optimized for each environmental luminance condition). As a result, several 3D LUTs may be generated and prestored, and interpolation between 3D LUTs may be performed on-the-fly to ensure optimal display image quality at any environmental luminance conditions.

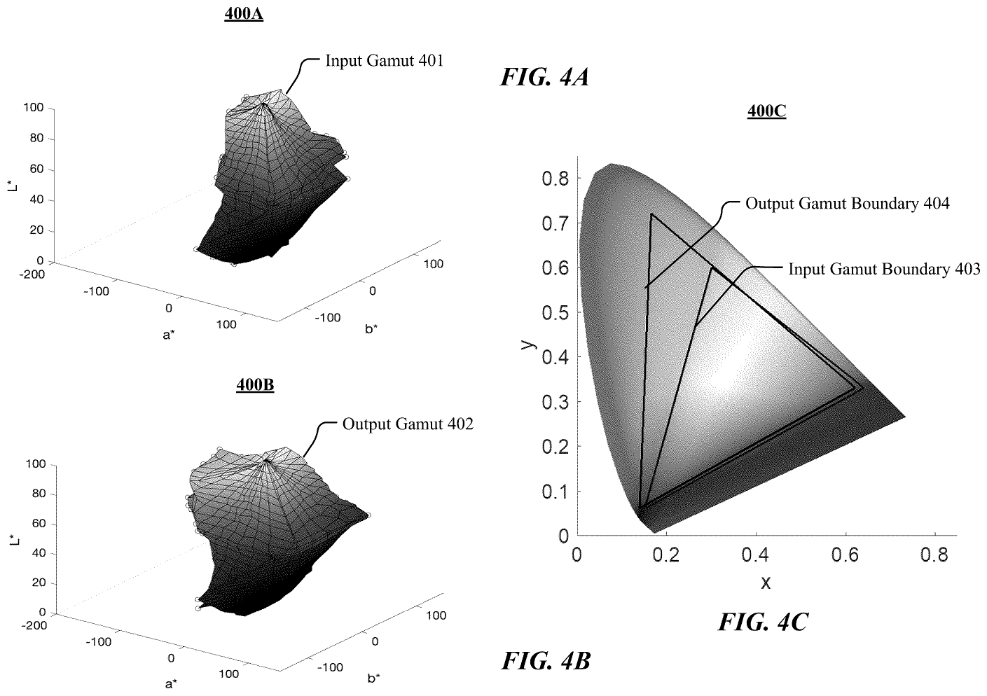

FIG. 4A illustrates an example input gamut 401 associated with images to be displayed. FIG. 4B illustrates an example output gamut 402 associated with the display for displaying images. FIG. 4C illustrates a comparison of the boundaries (e.g., 403, 404) of the example input gamut and output gamut. In particular embodiment, images to be displayed on AR displays may be associated with a particular gamut. The gamut associated with the images to be displayed may be referred to as the input gamut or image gamut. For example, images may usually have pixel color being defined in an sRGB color space corresponding to an sRGB gamut. In that case, the input gamut associated with the images to be displayed may be an sRGB gamut. However, AR displays may have a different color gamut than sRGB gamut. The gamut associated with the display may be referred to as the output gamut or display gamut. For example, the display gamut may have a larger or smaller volume than the image gamut. As another example, the display gamut may have a different size or/and shape than the image gamut. For some hues, the display gamut may have a larger range than the image gamut. For some other hues, the display gamut may have a smaller range than the image gamut. As shown in FIG. 4C, for a particular hue, the boundaries of the gamut can be approximated by respective triangles (e.g., 403, 404). Here, the output gamut boundary 404 may be greater than the input gamut boundary 403. Thus, gamut mapping may be needed from the input gamut (e.g., sRGB) of the images to the output gamut of the display for achieving an optimal display result.

In particular embodiments, for the tone mapping, the system may first determine a tone mapping curve which is customized based on the display and a number of other factors (e.g., the background luminance, the foreground luminance, the contrast of the foreground and background). The tone mapping curve may map the lightness of the input RGB values to new lightness levels with variable gains along the tone mapping curve. In particular embodiments, the system may generate a contrast objective function for performing a global tone mapping (GTM). The system may design the GTM to improve the contrast of combination image to have the same contrast of the original front image. In particular embodiments, the GTM contrast objective function may be designed by using the following equation:

$${min}_{GTM} C ( {img}_{FI}^{linear RGB} ) - C ( {img}_{Combine\_front}^{linear RGB} * GTM ) \qquad ( 1 )$$

where, C is the contrast function for images; FI is the foreground image shown in AR display; Combine_front is the foreground image in a combined image in linear RGB domain. The foreground image may have a compressed dynamic range a in linear RGB domain, as shown in the following equation:

$$α = 1 - \frac{BL}{BL + FL} \qquad ( 2 )$$

where, BL is the background luminance; FL is the peak foreground luminance. This GTM objective function may be determined through calculating the minimum contrast error between the original foreground image and the combined image to get the best global tone mapping in linear RGB domain.

In particular embodiments, the system may use a five-step process to perform the global tone mapping. First, the system may calculate the β in sRGB, using the FL, BL, and γ. In particular embodiments, the system may try to find the foreground's most accurate histogram distribution in a background environment in linear RGB. The GTM may be to transform the foreground lightness' histogram distribution in a background environment to match the original histogram distribution. The system may generate a tone mapping curve based on histogram matching process in the lightness distribution. The system may first calculate the value of β using the following equation:

$$β = 1 - {( \frac{BL}{BL + FL} )}^{\frac{1}{γ}} \qquad ( 3 )$$

where, γ is the display gamma which allows conversion between linear RGB and sRGB. This step may be to calculate the gray level dynamic range of the foreground in sRGB color space. Assuming BL=640 nits, FL=333 nits, and γ=2.4, the β value may be calculated by Equation (3) to be 1-0.84 and the dynamic range of the front image in the normalized sRGB domain may be [0.84, 1]. In the second step, the system may extract the valid gamma decoding curve within [0.84, 1] based on the β value in sRGB. In the third step, the system may normalize valid gamma decoding curve and do gamma decoding for front image accordingly. Afterward, linear RGB values may be obtained. In the fourth step, the RGB to L*a*b* color space conversion may be performed to extract lightness (L*), followed by computation of histogram distribution. Meanwhile, the original foreground image may go through the standard gamma decoding process (e.g., using gamma decoding curve across full dynamic range), where the corresponding L* histogram distribution may be extracted subsequently. In the final step, the system may use histogram matching to get the tone curve and optimize the new global tone mapping step size. The tone mapping curve may allow optimal histogram distribution of foreground lightness in a background environment.

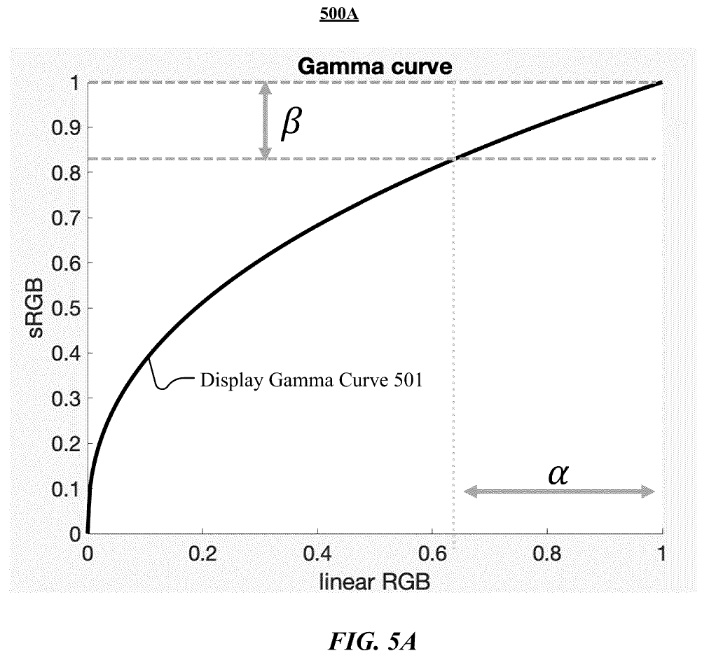

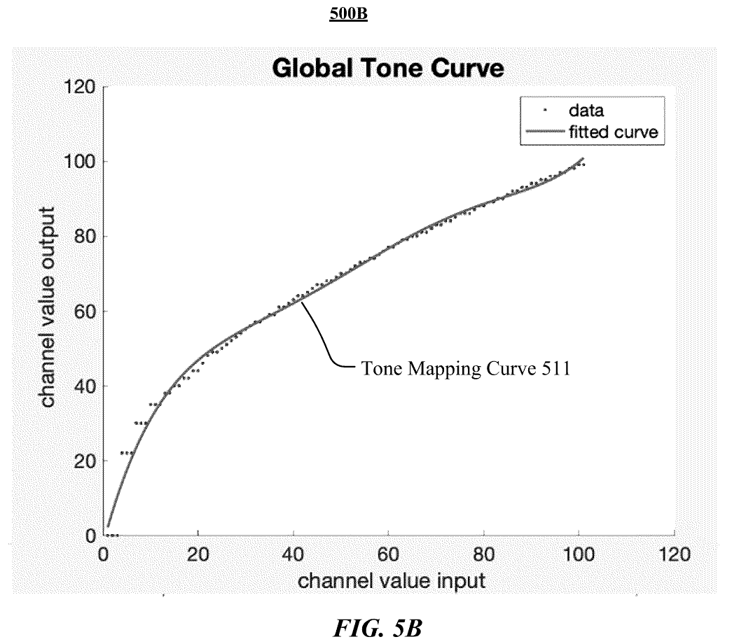

FIG. 5A illustrates an example display gamma curve 501 and the compressed dynamic range (α and β, respectively) for a foreground image in a background environment in linear RGB and sRGB domains. FIG. 5B illustrates an example tone mapping curve 511. In particular embodiments, the system may use tone mapping curves that are non-linear to scale the lower brightness with greater gain values and sale the higher brightness with smaller gain values. In particular embodiments, the tone mapping curve may be customized for the display device (e.g., AR displays) and different display devices may have different tone mapping curves. In particular embodiments, the tone mapping curve may be customized for different environmental luminance conditions (e.g., background luminance conditions). As an example and not by way of limitation, the system may generate the tone mapping curve based on gamma curve (e.g., gamma 1/2.4), as shown in in FIG. 5A, where the tone mapping curve derived is shown in FIG. 5B. In this example, the dimmest range of the curve may have the highest gain values and have a greater amount of change in the lightness of the input RGB values. The middle range may have relatively greater gain values (greater than the brightest range but less than the dimmest range). The lightest range may have the lowest the gain values. The tone mapping process may consider the input gamut boundary for the lightness range and avoid pushing the lightness level beyond the input gamut boundary (which would result in clipping effect). The tone mapping process may be performed in an L*C*H color space to the lightness (L*) at fixed hue (H) and chroma (C*) and the result will fit within the minimum and maximum lightness level. As a result, the lightness of input RGB values in different ranges may be mapped to different lightness levels in a non-proportional manner with different gain values. The details in the dimmest and middle range may become much brighter for an easy perception by viewers. In the meantime, the brightest range can avoid oversaturation effect. Also, the overall contrast of the images being viewed in AR (see-through) display may be generally maintained.

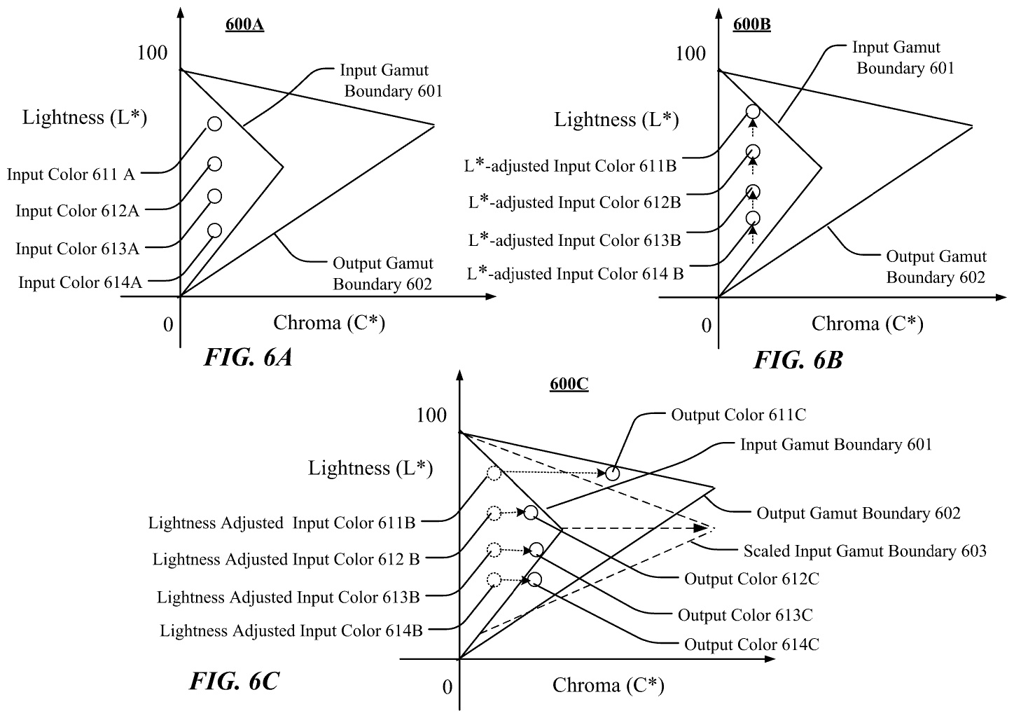

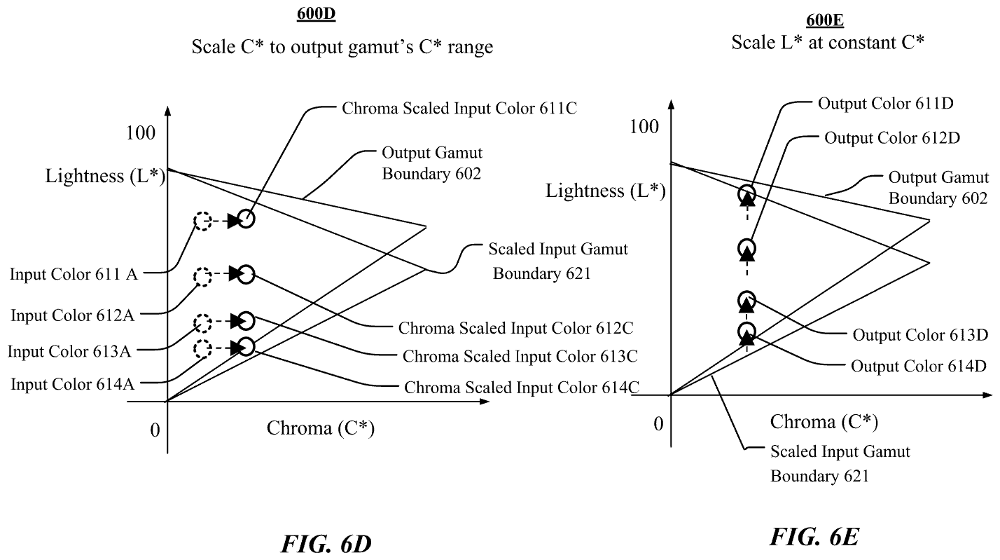

FIGS. 6A-6C illustrate an example process 600A, 600B, and 600C for using combined tone mapping and gamut mapping to optimize pixel colors of the images to be displayed. In particular embodiments, the system may use a combined approach of tone mapping and gamut mapping to optimize the image pixel colors. The system may first determine, for each color hue, an input gamut boundary in the lightness-chroma space of the sRGB gamut and an output gamut boundary in the lightness-chroma space as defined by the display gamut. Both of the input and output gamut boundaries may be approximated by respective triangles. For example, for a particular hue, the input gamut boundary may be approximated by the triangle 601 and the output gamut boundary may be approximated by the triangle 602 as shown in FIG. 6A. Four example input colors 611A, 612A, 613A, and 614A may be associated with the pixels of the image and fall within the input gamut boundary 601. The output gamut may be larger than the input gamut for this particular hue (as illustrated by the triangle 602 being larger than the triangle 601).

It is notable that, for both the input gamut and the output gamut, the gamut may have different lightness value ranges at different chroma values. For example, referring to the input gamut boundary 602, the input gamut at this hue angle may have a full lightness range of [0, 100] at the zero chroma and may have gradually smaller lightness ranges (as defined by the input gamut boundary 601) when the chroma increases. At the maximum chroma point of the input gamut, the lightness range may be reduced to zero. The greater chroma value may correspond to a higher level of colorfulness and the greater lightness value may correspond to a brighter visual effect. Tone mapping at a particular chroma may be limited or constrained by this lightness ranges as defined by the input gamut boundary 601 to avoid generating lightness saturation effect caused by pushing lightness beyond the input gamut boundary 601. Furthermore, the system may perform tone mapping to increase the lightness as much as possible but constrained by this lightness ranges as defined by the input gamut boundary 601.

In particular embodiments, the system may perform the tone mapping using the tone mapping curve and constrain the tone mapping results within the boundary of the input gamut. In particular embodiments, the system may first fit the tone mapping curve into the range of lightness (e.g., 30 to 70) at the corresponding hue angle and chroma, as defined by the input gamut boundary. Then, the system may adjust the tone mapping curve, clip or shirk the tone mapping curve to that range, and use the tone mapping curve to adjust the lightness value values but keeping the chroma and hue constant. After that, the system may scale the chroma proportionally (or with any fixed relationships) for gamut mapping. As an example and not by way of limitation, for the four input colors 611A, 612A, 613A, and 614A, as shown in FIG. 6A, the system may adjust their lightness (L*) using the tone mapping curve as described before. In other words, the system may take the lightness values of these input colors 611A, 612A, 613A, and 614A as the linear RGB inputs and may find the adjusted lightness values for these input colors (as shown by 611B, 612B, 613B, and 614B in FIG. 6B). The adjusted lightness of the input colors as shown by 611B, 612B, 613B, and 614B in FIG. 6B) may provide a better visibility for image details that are in relative dimmer ranges because the tone mapping curve may have relatively greater gain in the relatively dimmer ranges. At the same time, the adjusted lightness may allow the system to keep or improve the overall contrast level of the image. Furthermore, the tone mapping for adjusting the lightness of the input colors may be constrained within the maximum lightness and minimum lightness of this particular hue and chroma as confined by the up and bottom boundaries (e.g., 601) of the input gamut. With such a constraint, the system may avoid pushing the lightness to go beyond the input gamut boundaries and may eliminate the brightness saturation effect by avoiding the clipping effect on the brightness of the input colors.

In particular embodiments, the system may perform the gamut mapping after the tone mapping process. In some other embodiments, the system may first perform the gamut mapping and then perform the tone mapping later, as will be described later in this disclosure. For the gamut mapping (e.g., in an L*C*H color space), the system may scale the chroma from the range of the input gamut to match the chroma range of the output gamut, while keeping the lightness L* at a constant adjusted lightness (adjusted in the previous step). The scaling may be proportional, which means that the output chroma values in the output gamut can be proportional to the input chroma values in the input gamut range. As an example and not by way of limitation, as shown in FIGS. 6B-6C, for the four lightness adjusted input colors 611B, 612B, 613B, and 614B, the system may scale their chroma proportionally while scaling the maximum chroma value of the input gamut boundary to match the maximum chroma value of the output gamut boundary. In other words, the system may scale the input gamut boundary along the chroma dimension to match the output gamut boundary on the maximum chromas. At the same time, the system may scale the chromas of the lightness adjusted input colors 611B, 612B, 613B, and 614B proportionally to the scaling of the input gamut boundary to determine the output colors 611C. 612C. 613C, and 614C. As a result, the positions of the output colors 611C, 612C, 613C, and 614C with respect to the output gamut (as determined by their chroma values) may be proportional to the positions of the lightness adjusted input colors 611B, 612B, 613B, and 614B with respect to the input gamut boundary. By mapping the chroma values from the input gamut to the output gamut, the image color values may be optimized to maximize the usage of the output gamut range. As a result, the optimized image may be more colorful and provide better user experience. The gamut mapping may be based on, for example, but not limited to, LLIN or CLLIN method. With LLIN method, the chroma-adjusted output colors 611C, 612C, 613C, and 614C may be constrained within the output gamut boundary 602 directly after chroma mapping. With CLLIN method, the chroma-adjusted output colors 611C, 612C, 613C, and 614C may first be constrained within a scaled input gamut boundary (e.g., 603 in FIG. 6C dashed boundary). Afterward, the lightness of the colors may be adjusted proportionally to ensure that the final output colors are constrained within the output gamut boundary 602. Regardless of whether the gamut mapping step is performed in one step (e.g., LLIN) or multiple step (e.g., CLLIN) process, the final output colors may always be constrained with the output gamut boundary 602. The tone mapping and gamut mapping process may be repeated for each color hue associated with the input gamut space.

However, in particular embodiments, for gamut mapping, the scaling of chroma may not need to be proportional to the scaling of the input gamut boundary. In particular embodiments, the chroma values of the output colors within the output gamut boundary may have any pre-determined fixed relationship to the chroma values of the lightness adjusted input colors within the input gamut boundary. In other words, the chroma of the output colors may be determined based on the chroma of the lightness adjusted input colors but does not need to be proportional. For example, the chroma of the output colors may be mapped from the chroma of the lightness adjusted input colors based on a sigmoid function, where the middle range is better preserved compared to the high and low chroma ranges. For another example, a piecewise mapping function may be employed to tailor the chroma enhancement at different ranges and, collectively, enable better colorfulness while avoiding loss of details.

In particular embodiments, the system can perform the tone mapping first and perform the gamut mapping after that. Alternatively, the system can do it in a reserved order by performing the gamut mapping before performing tone mapping. For example, the system can first scale the chroma values by scaling the input gamut to match the output gamut along the chroma dimension, while keeping the lightness and the hue unchanged. Then, the system may use a tone curve to fit the lightness to the boundary of the output gamut. The end result may be similar, and the optimized image may have higher overall lightness to allow viewers to see more details and will be more colorful as perceived by the viewers.

FIGS. 6D-6E illustrate an example process where the system performs gamut mapping (600D) by scaling the chroma before performing tone mapping (600E) by scaling the lightness. As an example and not by way of limitation, referring to the input colors 611A, 612A, 613A, and 614A, the input gamut boundary 601 as shown in FIG. 6A, the system may first scale the chroma of the input colors 611A, 612A, 613A, and 614A while scaling the input gamut boundary 601 along the chroma dimension to match to the chroma range the output boundary 602. In other words, the system may scale the chroma of the input gamut boundary 601 to match the chroma range of the input gamut boundary 601 to the chroma range of the output gamut boundary 602. After scaled, the scaled input gamut boundary 621 may have a maximum chroma value that is equal to the maximum chroma value of the output gamut boundary 602. The chroma of the input colors 611A, 612A, 613A, and 614A may be proportionally or with a fixed non-proportional relationship, with respect to the scaling of the input gamut boundary 601 to the scaled input gamut boundary 621. In other words, the positions of chroma scaled input colors 611C, 612C, 613C, and 614C with the chroma range of the scaled input gamut boundary 621 may be proportional or have a fixed non-proportional relationship to the positions of the input colors 611A, 612A, 613A, and 614A within the chroma range of the input gamut boundary 601. During this gamut mapping process to match the chroma range of the input gamut to the output gamut, the lightness of all input colors may be kept constant.

After the system performed gamut mapping by scaling the chroma to match the chroma range of the input gamut and output gamut, the system may perform tone mapping by scaling the lightness of the chroma scaled input colors 611C, 612C, 613C, and 614C, but keep the chroma of all colors constant in this step. The tone mapping process may be based on the tone mapping curve as described above. It is notable that regardless of whether tone mapping is performed before or after gamut mapping, the final colors after combined tone and gamut mapping may be preserved within output gamut boundary 602. In the former case, tone-mapped colors may be constrained within the input gamut boundary 601 only at the first step. Afterward, the tone-mapped colors may be expanded to cover more output gamut at the gamut mapping stage. In the latter case, tone mapping may be performed after gamut mapping, where the tone mapping process is aware of the output gamut boundary 602 and ensure that final colors are constrained within it. As a result, for both cases, the system may generate the output colors 611D, 612D, 613D, and 614D that provide better visibility for details, and more colorful visual effect that maximizes the usage of the output gamut of the display, while ensuring the final colors reproduced do not exceed the output gamut of the display (hence avoid oversaturation or clipping effect).

In particular embodiments, the system may use the gamut mapping method that scale the chroma while keeping the lightness constant. For example, the system may use a linear scaling in lightness (LLIN) method to scale the input gamut along the chroma dimension while keeping the lightness constant in a process where the tone mapping (lightness adjustment) is performed before the gamut mapping (chroma scaling). The LLIN method may perform linear chroma mapping at constant lightness. As another example, the system may use a CLLIN method to scale the input gamut along the chroma dimension while keeping the lightness constant in a process where the tone mapping (lightness adjustment) is performed after the gamut mapping (chroma scaling). For another example, the combined chroma and lightness scaling process in CLLIN method can be treated as a gamut mapping process, which can be applied after tone mapping (i.e. the system may first perform tone mapping, and then use a CLLIN gamut mapping method to first scale the input colors along the chroma dimension and then apply addition mapping along the lightness dimension). In such case, tone mapping contributes to the main lightness adjustment (enhance visibility of a see-through display under the impact of environmental luminance), whereas the gamut mapping process further refine the lightness adjustment for optimal color appearance (accounting for the inherence lightness range difference between input sRGB gamut and display output gamut). In these two gamut mapping examples above (LLIN and CLLIN), the chroma and the lightness may be adjusted or scaled separately while keeping the other one constant. However, in some other embodiments, the system may use methods that scale or adjust the chroma and lightness simultaneously.

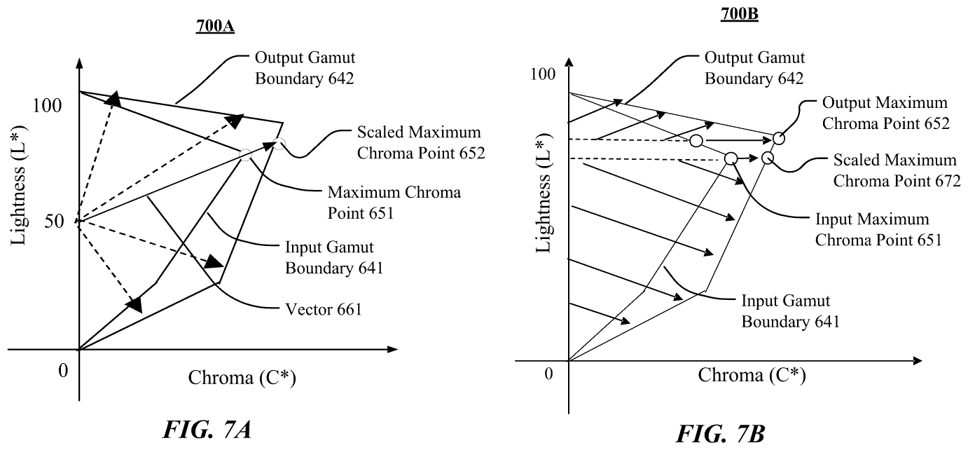

FIG. 7A illustrates an example process 700A to scale both the chroma and lightness simultaneously from a centroid of the input gamut. As an example and not by way of limitation, the system may use a simultaneous lightness and chroma mapping (SLIN) method to scale the chroma and lightness simultaneously from the centroid (50, 0) of the input gamut to match the output gamut. The system may scale the chroma and lightness simultaneously along a number of vectors starting from the centroid (50, 0) and radially pointing to the output gamut boundary 642. The system may use the maximum chroma point 651 of the input gamut as a reference point and scale the input gamut boundary 641 along the vector 661. The vector 661 may start from the centroid (50, 0) and point to the output gamut boundary 642, crossing the maximum chroma point 651. The system may scale the input gamut boundary 641 along the vector 661 until the maximum chroma point 651 reaches the output gamut boundary 642. At the same time, for each input color, the system may proportionally scale the lightness and chroma of that input color along a vector starting from the centroid crossing that input color position and pointing to the output gamut boundary 652 or scale the lightness and chroma of that input color with any fixed relationship to the scaling of the input gamut boundary 641. The system may scale the chroma and lightness of all input colors along respective vectors that passes through these input color positions. As a result, the system may determine the output colors based on the scaled chroma and lightness of the input colors along respective vectors. The output color positions within the output gamut boundary 642 may be proportional (or with other fixed relationship) to the respective input color positions within the input gamut boundary 641 along the respective vectors.

FIG. 7B illustrates an example process to scale both the chroma and lightness simultaneously from variable focal points. As an example and not by way of limitation, the system may use a method to scale the chroma and lightness simultaneously from a series of variable focal points. The system may first determine a series of focal points on the lightness axis within the range of the input gamut. The focal points may be determined based on the input lightness (L*) range. For input colors with L* falling between the input and output cusps (i.e., the maximum chroma points 651 and 652), a reference point corresponding to a vector parallel to the chroma axis may be determined. Thus, the input cusp (i.e., the maximum chroma point 651) may be mapped to the point 672 at a constant L*. For colors with L* falling in other ranges, a series of focal points may be determined based on the predetermined L* to C* slope. Then, the system may determine a number of vectors starting from respective focal points and radically pointing to the output gamut boundary 642 along two or more predetermined directions. After that, the system may scale the chroma (C*) and lightness (L*) simultaneously along corresponding vectors. The system may use the maximum chroma point 651 of the input gamut as a reference point and scale the input gamut boundary 641 along the chroma axis. The system may scale the input gamut boundary 641 along the chroma axis until the maximum chroma point 651 reaches the output gamut boundary 642 at the position of the scaled maximum chroma point 672. At the same time, for each input color, the system may proportionally scale the lightness and chroma of that input color along a vector starting from a corresponding focal point crossing that input color position and pointing to the output gamut boundary 642. Alternatively, the system may scale the lightness and chroma of that input color with any fixed relationship to the scaling of the input gamut boundary 642. The system may scale the chroma and lightness of all input colors along respective vectors that passing through these input color positions. As a result, the system may determine the output colors based on the scaled chroma and lightness of the input colors along respective vectors. The output color positions within the output gamut boundary 642 may be proportional (or with other fixed relationship) to the respective input color positions within the input gamut boundary 641 along the respective vectors.

However, computing on-the-fly may be too demanding to the computational resources and power. As such, the system pre-computes a 3D LUT (three-dimensional look-up table) which combines both the tone mapping and the gamut mapping. At run time, the system can access the 3D LUT which directly provides the output colors based on the input colors. As a result, the tone mapping and gamut mapping may be not performed at runtime to minimize computational resources or power. For example, at run time, the system may input to the 3D LUT the colors of particular pixels to determine where they are mapped to by the 3D LUT (e.g., where the output colors are positioned in the output gamut and what are the adjusted lightness values). Then, the system may determine the output colors for the input colors and use the output color to represent the input colors of the image. As a result, the system may reproduce the image colors with optimized display results.

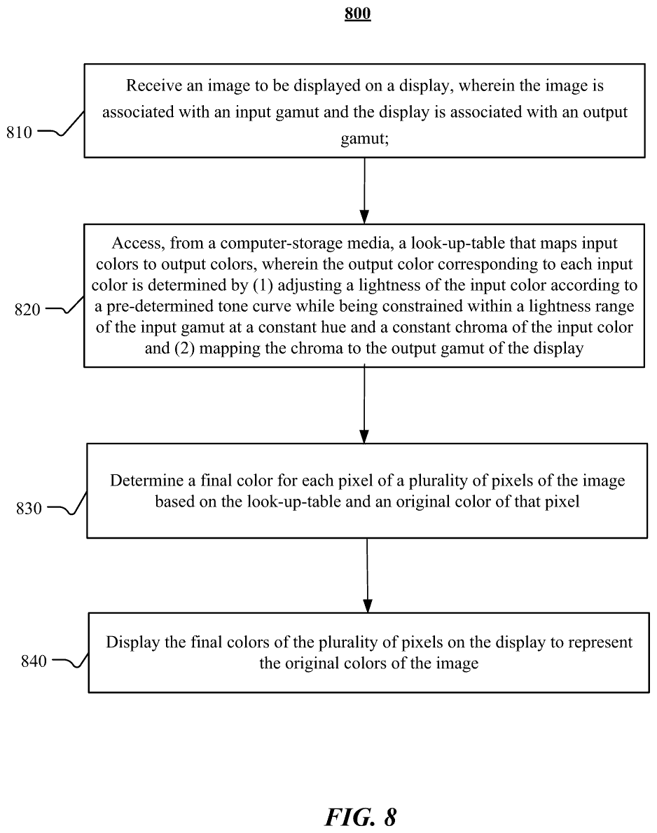

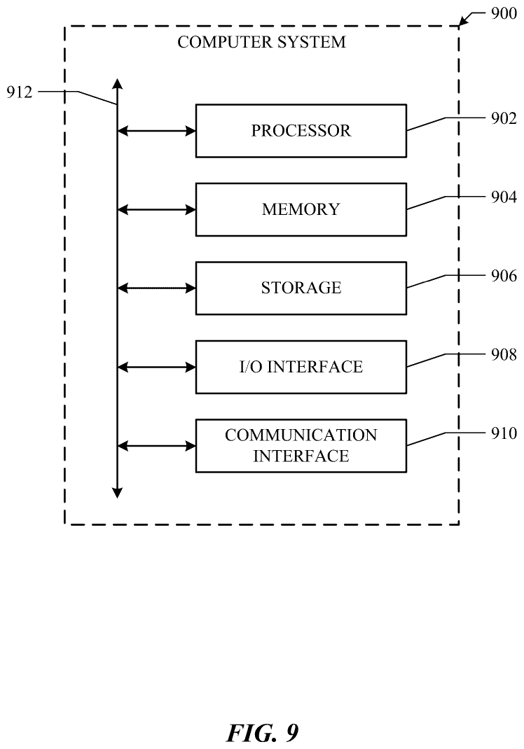

FIG. 8 illustrates an example method 800 for displaying an image using combined tone and gamut mapping technique. The method may begin at step 810, where a computing system may receive an image to be displayed on a display. The image may be associated with an input gamut and the display is associated with an output gamut. At step 820, the system may access, from a computer-storage media, a look-up-table (e.g., 3D LUT) that maps input colors to output colors. The output color corresponding to each input color may be determined by (1) adjusting a lightness of the input color according to a pre-determined tone curve while being constrained within a lightness range of the input gamut at a hue and a chroma (e.g., a constant hue and a constant chroma) of the input color and (2) mapping the chroma to the output gamut of the display. At step 830, the system may determine a final color for each pixel of the pixels of the image based on the look-up-table and an original color of that pixel. At step 840, the system may display the final colors of the pixels on the display to represent the original colors of the image.

In particular embodiments, the hue and the chroma of the input color may be kept constant while the lightness of the input color is adjusted according to the pre-determined tone curve. In particular embodiment, adjusting the lightness of the input color according to the pre-determined tone curve constrained within the lightness range of the input gamut may eliminate a color saturation effect in the displayed final colors. In particular embodiments, the display may be an augmented reality display. The pre-determined tone curve may be customized for the augmented reality display based on a number of factors comprising a background illuminance, a foreground illuminance, a foreground dynamic range, etc. In particular embodiments, the pre-determined tone curve may provide greater gain values in a first lightness range than a second lightness range. The lightness in the first lightness range may be dimmer than the lightness in the second lightness range.

In particular embodiments, the final colors of the pixels displayed on the display may represent one or more details of the image with a better visibility than the original colors of the image. In particular embodiments, the final colors of the pixels may be displayed in a background environment. The final colors of the pixels of the image may represent the image with an increased contrast with respect to the background environment comparing to the original color of the pixels of the image. In particular embodiments, the output gamut may have a greater volume than the input gamut. Mapping the chroma to the output gamut of the display may include scaling the chroma proportionally while scaling the first gamut along a chroma dimension to match a first maximum chroma of the input gamut to a second maximum chroma of the output gamut.

In particular embodiments, mapping the chroma to the output gamut of the display may include scaling the chroma while keeping a fixed pre-determined relation between positions of the chroma in the input gamut and the output gamut to match a first maximum chroma of the input gamut to a second maximum chroma of the output gamut. In particular embodiments, the look-up-table may be a three-dimensional look-up-table. The lightness of the input colors may be adjusted according to the pre-determined tone curve before mapping the chroma to the output gamut of the display. In particular embodiments, the look-up-table may be a three-dimensional look-up-table and the lightness of the input colors may be adjusted according to the pre-determined tone curve after mapping the chroma to the output gamut of the display. In particular embodiments, the look-up-table may be generated by scaling the chroma proportionally while scaling the input gamut along a chroma dimension to match a first maximum chroma of the input gamut to a second maximum chroma of the output gamut and keeping the lightness of the input color constant.

In particular embodiments, the look-up-table may be generated by simultaneously scaling the chroma and the lightness of the input color along a vector starting from a centroid point of the input gamut pointing to a boundary position of the output gamut. In particular embodiments, the look-up-table may be generated by simultaneously scaling the chroma and the lightness of the input color along a vector starting from a variable focal point of the input gamut pointing to a boundary position of the output gamut.

Particular embodiments may repeat one or more steps of the method of FIG. 8. where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for displaying an image using combined tone and gamut mapping technique including the particular steps of the method of FIG. 8, this disclosure contemplates any suitable method for displaying an image using combined tone and gamut mapping technique including any suitable steps, which may include all, some, or none of the steps of the method of FIG. 8, where appropriate. Furthermore, although this disclosure describes and illustrates particular components, devices, or systems carrying out particular steps of the method of FIG. 8. this disclosure contemplates any suitable combinations of any suitable components, devices, or systems carrying out any suitable steps of the method of FIG. 8.

FIG. 10 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
receiving an image to be displayed on a display, wherein the image is associated with an input gamut and the display is associated with an output gamut;
accessing, from a computer-storage media, a look-up-table that maps input colors to output colors, wherein the output color corresponding to each input color is determined by (1) adjusting a lightness of the input color according to a pre-determined tone curve while being constrained within a lightness range of the input gamut at a hue and a chroma of the input color and (2) mapping the chroma to the output gamut of the display;
determining a final color for each pixel of a plurality of pixels of the image based on the look-up-table and an original color of that pixel; and
displaying the final colors of the plurality of pixels on the display to represent the original colors of the image.

2. The method of claim 1, wherein the hue and the chroma of the input color are kept constant while the lightness of the input color is adjusted according to the pre-determined tone curve.

3. The method of claim 2, wherein adjusting the lightness of the input color according to the pre-determined tone curve constrained within the lightness range of the input gamut eliminates a color saturation effect in the displayed final colors.

4. The method of claim 1, wherein the display is an augmented reality display, and wherein the pre-determined tone curve is customized for the augmented reality display based on a plurality of factors comprising a background illuminance, a foreground illuminance, and a foreground dynamic range.

5. The method of claim 1, wherein the pre-determined tone curve provides greater gain values in a first lightness range than a second lightness range, and wherein the first lightness range is dimmer than the second lightness range.

6. The method of claim 1, wherein the final colors of the plurality of pixels displayed on the display represent one or more details of the image with a better visibility than the original colors of the image.

7. The method of claim 1, wherein the final colors of the plurality of pixels are displayed in a background environment, and wherein the final colors of the plurality of pixels represent the image with an increased contrast with respect to the background environment comparing to the original color of the plurality of pixels of the image.

8. The method of claim 1, wherein the output gamut has a greater volume than the input gamut, and wherein mapping the chroma to the output gamut of the display comprising:
scaling the chroma proportionally while scaling the first gamut along a chroma dimension to match a first maximum chroma of the input gamut to a second maximum chroma of the output gamut.

9. The method of claim 1, wherein mapping the chroma to the output gamut of the display comprising:
scaling the chroma while keeping a fixed pre-determined relation between positions of the chroma in the input gamut and the output gamut to match a first maximum chroma of the input gamut to a second maximum chroma of the output gamut.

10. The method of claim 1, wherein the look-up-table is a three-dimensional look-up-table, and wherein the lightness of the input colors is adjusted according to the pre-determined tone curve before mapping the chroma to the output gamut of the display.

11. The method of claim 1, wherein the look-up-table is a three-dimensional look-up-table, and wherein the lightness of the input colors is adjusted according to the pre-determined tone curve after mapping the chroma to the output gamut of the display.

12. The method of claim 1, wherein the look-up-table is generated by scaling the chroma proportionally while scaling the input gamut along a chroma dimension to match a first maximum chroma of the input gamut to a second maximum chroma of the output gamut and keeping the lightness of the input color constant.

13. The method of claim 1, wherein the look-up-table is generated by simultaneously scaling the chroma and the lightness of the input color along a vector starting from a centroid point of the input gamut pointing to a boundary position of the output gamut.

14. The method of claim 1, wherein the look-up-table is generated by simultaneously scaling the chroma and the lightness of the input color along a vector starting from a variable focal point of the input gamut pointing to a boundary position of the output gamut.

15. One or more computer-readable non-transitory storage media embodying software that is operable when executed to:
receive an image to be displayed on a display, wherein the image is associated with an input gamut and the display is associated with an output gamut;
access, from a computer-storage media, a look-up-table that maps input colors to output colors, wherein the output color corresponding to each input color is determined by (1) adjusting a lightness of the input color according to a pre-determined tone curve while being constrained within a lightness range of the input gamut at a hue and a chroma of the input color and (2) mapping the chroma to the output gamut of the display;
determine a final color for each pixel of a plurality of pixels of the image based on the look-up-table and an original color of that pixel; and
display the final colors of the plurality of pixels on the display to represent the original colors of the image.

16. The media of claim 15, wherein the hue and the chroma of the input color are kept constant while the lightness of the input color is adjusted according to the pre-determined tone curve.

17. The media of claim 15, wherein adjusting the lightness of the input color according to the pre-determined tone curve constrained within the lightness range of the input gamut eliminates a color saturation effect in the displayed final colors.

18. A system comprising:
one or more non-transitory computer-readable storage media embodying instructions; and
one or more processors coupled to the storage media and operable to execute the instructions to:
receive an image to be displayed on a display, wherein the image is associated with an input gamut and the display is associated with an output gamut;
access, from a computer-storage media, a look-up-table that maps input colors to output colors, wherein the output color corresponding to each input color is determined by (1) adjusting a lightness of the input color according to a pre-determined tone curve while being constrained within a lightness range of the input gamut at a hue and a chroma of the input color and (2) mapping the chroma to the output gamut of the display;
determine a final color for each pixel of a plurality of pixels of the image based on the look-up-table and an original color of that pixel; and
display the final colors of the plurality of pixels on the display to represent the original colors of the image.

19. The system of claim 18, wherein the hue and the chroma of the input color are kept constant while the lightness of the input color is adjusted according to the pre-determined tone curve.

20. The system of claim 18, wherein adjusting the lightness of the input color according to the pre-determined tone curve constrained within the lightness range of the input gamut eliminates a color saturation effect in the displayed final colors.
